(19) United States
(12) Patent Application Publication
(10) Pub. No.: US 2024/0010552 A1
(43) Pub. Date: Jan. 11, 2024

(54) NEAR INFRARED TRANSPARENT, VISIBLE LIGHT ABSORPTIVE COATING AND GLASS SUBSTRATE WITH COATING

(71) Applicant: Schott AG, Mainz (DE)

(72) Inventors: Yakup Gönüllü, Essenheim (DE); Thorsten Schneider, Nackenheim (DE); Nikolaus Schultz, Essenheim (DE); Thorsten Damm, Eltville am Rhein (DE)

(73) Assignee: Schott AG, Mainz (DE)

(21) Appl. No.: 18/471,939

(22) Filed: Sep. 21, 2023

Related U.S. Application Data
(63) Continuation of application No. PCT/EP2022/057086, filed on Mar. 17, 2022.

(30) Foreign Application Priority Data
Mar. 25, 2021 (EP) 21164849.8
Mar. 17, 2022 (WO) PCT/EP2022/057086

(51) Int. Cl. C03C 17/34; G02B 5/28

(52) U.S. Cl. CPC C03C 17/3482; G02B 5/289; G02B 5/281; C03C 2217/91; C03C 2218/153

(57) ABSTRACT

A coating for a glass substrate is a multilayer coating including at least one silicon layer. The at least one silicon layer has a carbon content gradient over its layer thickness.

### CROSS REFERENCE TO RELATED APPLICATIONS

This is a continuation of International Patent Application No. PCT/EP2022/057086 filed on Mar. 17, 2022, which is incorporated in its entirety herein by reference. International Patent Application No. PCT/EP2022/057086 claims priority to European Patent Application No. 21164849.8 filed on Mar. 25, 2021, which is incorporated in its entirety herein by reference.

### BACKGROUND OF THE INVENTION

### 1. Field of the Invention

The present invention relates to a coating for a glass substrate, a glass substrate with a coating and a method for producing a coating on a substrate. In particular, the present invention relates to a near infrared transparent, visible light absorptive coating for a glass substrate as well as a respectively coated glass substrate and a method for respectively coating a substrate. In an exemplary application of the invention, the coated glass substrate can be a sensor window, in particular for an optical sensor system such as a LiDAR-system.

### 2. Description of the Related Art

Sensor systems, in particular optical sensor systems, usually require one or more optical window(s) through which the sensor system emits and receives light. The at least one optical window is located between the optoelectronic components of the sensor system and the environment to provide mechanical protection of the optoelectronic components against environmental influences. Known sensor systems can be provided with planar window(s) and/or curved window(s).

For example, LiDAR (Light Detection And Ranging)-systems enable optical distance and velocity measurement using laser light. For this purpose, LiDAR systems emit laser beams in the near infrared spectrum (NIR), i.e. laser beams with wavelengths above 780 nm, which are reflected by objects in the environment, at least partially return to and are detected by the LiDAR system. The emitted and reflected laser beams thereby pass through at least one optical window of the LiDAR system. By means of the pattern of the reflected beams, the LiDAR system can detect objects and by means of the time of flight of the laser beams, it can calculate the distance of these objects. Some LiDAR systems can also calculate the velocities of objects on the basis of phase relationships between the emitted and reflected beams.

In order to protect the optoelectronic components of the sensor system from visible light, e.g. to prevent negative impact of visible and UV light and/or to provide a clean and aesthetic visual appearance, optical sensor windows are often provided with a coating that is substantially opaque for visible light and substantially transparent for light in a certain spectral range of the working wavelength of the system.

Document US 2019/285785 A1 discloses a sensor window including a substrate and a set of layers disposed onto the substrate. The set of layers includes a first subset of layers of a first refractive index and a second set of layers of a second refractive index different from the first refractive index.

Document US 2018/231791 A1 discloses an optical filter including a substrate. The optical filter comprises a set of alternating high refractive index layers and low refractive index layers disposed onto the substrate. The set of alternating high refractive index layers and low refractive index may layers can be disposed such that a first polarization of incident light with a spectral range of less than 800 nm is reflected by the optical filter and a second polarization of incident light with a spectral range of more than 800 nm is passed through by the optical filter. The high refractive index layers may be hydrogenated silicon (Si:H). The low refractive index layers may be silicon dioxide (SiO₂).

However, in prior art coatings a plurality of layers must be provided in order to achieve the desired optical filter characteristics. Consequently, prior art coatings with multiple layers may have a relatively large and thus undesired cumulative thickness.

What is needed in the art is a way to provide a coating for a glass substrate, a glass substrate with a coating and a method for producing a coating on a substrate, which overcome the disadvantages of the prior art.

What is needed in the art is a way to provide a coating for a glass substrate, a glass substrate with a coating and a method for producing a coating on a substrate, which allows a reduction of the number of layers for providing the desired optical characteristics.

### SUMMARY OF THE INVENTION

In some embodiments provided according to the invention, a coating for a glass substrate is provided. The coating is a multilayer coating including at least one silicon layer. The at least one silicon layer has a carbon content gradient over its layer thickness.

In some embodiments provided according to the invention, a glass substrate includes at least one surface portion and a coating provided on the at least one surface portion. The coating is a multilayer coating including at least one silicon layer. The at least one silicon layer has a carbon content gradient over its layer thickness.

In some embodiments provided according to the invention, a method for producing a coating on a substrate includes: providing the substrate in a vacuum chamber; and depositing at least one layer to the substrate by a chemical vapor deposition method. The at least one layer is a silicon layer having a carbon content gradient over its layer thickness.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows a diagram with results of a ToF-SIMS analysis of one silicon layer of a coating provided according to the invention, showing content of trace elements carbon, 30Si-isotope, chlorine and sulfur comprised in the silicon layer;

FIG. 2 shows a diagram with results of the ToF-SIMS analysis of the one silicon layer of FIG. 1, showing content of trace elements silicon dioxide, oxygen, hydrogen and aluminum comprised in the silicon layer;

FIG. 3 shows a diagram with results of the ToF-SIMS analysis of the one silicon layer of FIG. 1, showing content of trace elements silicon nitride, fluorine, boron and NH comprised in the silicon layer;

FIG. 4 shows a diagram with results of a ToF-SIMS analysis of an embodiment of a coating provided according to of the invention comprising 24 layers, including twelve silicon and twelve silicon dioxide layers, showing content of trace elements carbon, 30Si-isotope and fluorine comprised in the coating;

FIG. 5 shows a diagram with results of the ToF-SIMS analysis of the coating of FIG. 4, showing content of trace elements silicon dioxide, oxygen and sulfur comprised in the coating;

FIG. 6 shows a diagram with results of the ToF-SIMS analysis of the coating of FIG. 5, showing content of trace elements silicon carbide and silicon nitride comprised in the coating;

FIG. 7 shows a diagram with the measurement results of FIG. 4 for carbon content and for 30Si-isotope in more detail;

FIG. 8 shows a diagram with the measurement results of FIG. 4 for carbon content normalized relative to the 30Si-isotope;

FIG. 9 shows a diagram with further measurement results for hydrogen content in the coating of FIG. 4 normalized relative to the 30Si-isotope;

FIG. 10 shows a diagram with the measurement results of FIG. 4 for fluorine content normalized relative to the 30Si-isotope;

FIG. 11 shows a diagram with the measurement results of FIG. 6 for silicon nitride content normalized relative to the 30Si-isotope;

FIG. 12 shows a diagram with further measurement results for chlorine content in the coating of FIG. 4 normalized relative to the 30Si-isotope;

FIG. 13 shows a diagram with refractive index measurement results and absorption coefficient measurement results of one hydrogenated silicon layer of a coating provided according to the invention, which hydrogenated silicon layer has been deposited without supplementing additional hydrogen gas during deposition of the hydrogenated silicon layer;

FIG. 14 shows a diagram with refractive index measurement results and absorption coefficient measurement results of one hydrogenated silicon layer of a coating provided according to the invention, which hydrogenated silicon layer has been deposited with supplementing additional hydrogen gas during deposition of the hydrogenated silicon layer;

FIG. 15 shows a diagram with a comparison of the refractive index gradients of a hydrogenated silicon layer deposited without supplementing additional hydrogen gas during deposition of the hydrogenated silicon layer, and a hydrogenated silicon layer deposited with supplementing additional hydrogen gas during deposition of the hydrogenated silicon layer;

FIG. 16 shows a diagram with a comparison of reflection of a coating comprising silicon layers with carbon content gradient and reflection of a prior art coating comprising silicon layers without carbon content gradient;

FIG. 17 shows another diagram with a comparison of reflection of a coating comprising silicon layers with carbon content gradient and reflection of a prior art coating comprising silicon layers without carbon content gradient;

FIG. 18 shows a diagram with a comparison of transmission of a coating comprising silicon layers with carbon content gradient and transmission of a prior art coating comprising silicon layers without carbon content gradient; and

FIG. 19 shows a schematic view of a glass substrate with a coating provided according to the invention.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

In some embodiments, the present invention provides a coating for a glass substrate, in particular for a curved glass substrate. The coating is a multilayer coating comprising at least one silicon layer. The at least one silicon layer has a carbon content gradient over its layer thickness. Having a carbon content gradient can mean that the at least one silicon layer has a differing distribution of carbon element traces over its thickness, i.e. that an amount of carbon traces has a gradient through the silicon layer with respect to the layer thickness.

The at least one silicon layer can be a continuous elementary layer or monolayer. Hence, the at least one silicon layer can be denoted a single silicon layer. Silicon layer as used herein does not constitute a merely silicon-containing layer such as SiO₂, SiGe, etc. The at least one silicon layer can comprise only trace amounts (such as less than 0.1 mol %) of other elements such as carbon, hydrogen, nitrogen, fluorine, nitrogen, oxygen and/or chlorine. Optionally, the at least one silicon layer can be a hydrogenated amorphous silicon (a-Si:H) layer.

The carbon content gradient within the at least one silicon layer can be provided by producing the coating by a plasma impulse chemical vapor deposition method (PICVD). Hence, the coating can be a plasma impulse chemical vapor deposited coating. Details concerning the production of the coating will be described in more detail in the context of the method provided according to the invention.

Providing the carbon content gradient within the at least one silicon layer results in a refractive index gradient within the at least one silicon layer over its layer thickness, in particular with respect to light of specific wavelengths. The refractive index gradient within the at least one silicon layer in turn leads to self-reflecting effects within the at least one silicon layer and/or between the layers of the multilayer coating. In fact, a possible advantage of having a refractive index gradient in a single coating layer (a monolayer) is that even a single layer can function as an interference filter. Consequently, by having the carbon content gradient within the at least one silicon layer and the resulting refractive index gradient and self-reflecting effects, desired optical characteristics of the multilayer coating can be achieved with a lower number of layers compared to common multilayer coatings with a constant uniform refractive index within each layer. Thus, the stack layer number and the cumulative thickness of the coating can be reduced compared to common prior art coating with layers having a constant uniform refractive index. At the same time, by decreasing the number of layers, the number of process steps and thus the deposition time can be reduced.

Further, the coating provided according to the invention can be applied uniformly even to complicatedly curved substrate surfaces by producing the coating by a chemical vapor deposition process, in particular a PICVD process.

The coating can constitute a filter coating or an interference coating. In other words, the coating can be applied as an optical filter or an interference filter. Basically, already the at least one silicon layer with a refractive index gradient over its layer thickness can constitute an optical filter or an interference filter.

In particular, the at least one silicon layer can have a refractive index gradient over its layer thickness so as to implement a high transmission at least for light with a wavelength between 800 nm and 1600 nm, optionally 900 nm or more, and a minimal transmission for light with wavelengths in the UV-VIS (ultraviolet-visible) range. In this case, the coating provided according to the invention can be used as an optical filter or an interference filter for optical sensor systems, such as LiDAR-systems.

The at least one silicon layer can have a refractive index gradient over its layer thickness at least for light with a wavelength between 780 nm and 3 μm, optionally between 900 nm and 2 μm, in particular for light at 905 nm and/or 1550 nm.

For example, regarding all or some of the embodiments, the refractive index gradient in relation to the thickness of the layer can be measured at 782 nm by elipsometry.

The carbon content gradient can be increased, i.e. a sharper carbon content gradient can be provided in the at least one silicon layer, by supplying additional hydrogen gas during deposition of the at least one hydrogenated silicon layer by a PICVD process. The silicon layer can be hydrogenated by supplying hydrogen gas in the range of 10 ppm to 1000 ppm into the vacuum chamber during depositing of the silicon layer.

Within the at least one silicon layer (Si:H) the refractive index n for light with a wavelength between 780 nm and 3 μm, optionally between 900 nm and 2 μm, such as for light at 905 nm and/or 1550 nm can increase over the layer thickness of 100 nm by at least 4%, optionally at least 5%, optionally at least 6%, viewed from an exposed external surface (air side) in direction towards an inner surface facing the coated substrate (glass side) of the silicon layer.

Within the at least one silicon layer (Si:H) the refractive index n for light with a wavelength between 780 nm and 3 μm, optionally between 900 nm and 2 μm, such as for light at 905 nm and/or 1550 nm, can increase over the layer thickness of 100 nm by at least 20%, optionally at least 22%, optionally at least 24%, viewed from an exposed external surface (air side) in direction towards an inner surface facing the coated substrate (glass side) of the silicon layer.

The changing refractive index of the at least one silicon layer (changing over the layer thickness of the at least one silicon layer) for light of a wavelength between 780 nm and 3 μm, optionally between 900 nm and 2 μm, such as for light at 905 nm and/or 1550 nm can be between 2.8 and 4.0. At any point within the at least one silicon layer the measured refractive index can be at least 2.8, optionally at least 3.0, still optionally at least 3.1. At any point within the at least one silicon layer the measured refractive index can be 4.0 or less, optionally 3.9 or less, still optionally 3.85 or less.

The at least one silicon layer can comprise at least 95% silicon (namely atomic percent), optionally at least 97% silicon (namely atomic percent), optionally at least 99% silicon (namely atomic percent). The remaining percentage amount can comprise trace amounts of carbon, hydrogen, nitrogen, fluorine, nitrogen, oxygen and/or chlorine. Trace amounts (such as less than 0.1 mol %) of these elements can further influence the optical characteristics of the at least one silicon layer and the coating, in particular the refractive index gradient.

The at least one silicon layer can comprise less than 5% carbon and/or hydrogen, optionally less than 3%, optionally less than 1%. The at least one silicon layer can comprise less than 5% carbon, optionally less than 3%, optionally less than 1%. The at least one silicon layer can comprise less than 5% hydrogen, optionally less than 3%, optionally less than 1%. Optionally, the at least one silicon layer can comprise less than 5% carbon and hydrogen cumulatively, optionally less than 3%, optionally less than 1%. The specified percentages constitute atomic-%.

The following embodiments with quantified ratios and/or increases of carbon content can result in particularly advantageous self-reflecting effects.

In some embodiments, the at least one silicon layer can comprise a thickness section of 50 nm over which the carbon content increases at least 0.1%, optionally at least 1%, optionally at least 5% viewed in a direction away from the glass substrate. The carbon content can increase between 0.1% and 5% over the thickness section.

In some embodiments, the at least one silicon layer can comprise a thickness section of 30 nm over which the carbon content increases at least 0.1%, optionally at least 0.5%, optionally 1%, viewed in a direction away from the glass substrate. The carbon content can increase between 0.1% and 1% over the thickness section.

In some embodiments, the at least one silicon layer can comprise a thickness section of 100 nm over which the carbon content increases at least 0.5%, optionally at least 2%, optionally at least 6% viewed in a direction away from the glass substrate. The carbon content can increase between 0.5% and 6% over the thickness section.

The carbon content, as well as contents of other trace elements, in the at least one silicon layer can be obtained by a ToF-SIMS (Time-of-Flight Secondary Ion Mass Spectrometry). ToF-SIMS provides a commercially available and easy to use tool for determining the trace element contents in a precise manner. The person skilled in the art knows that depending on the sputter time (say 3500 s) a certain depth range (say up to 2 μm to 3 μm) starting from the outer surface of the coating into the coating, i.e. in a direction towards the glass substrate, can be evaluated. In other words, during applying the time-of-flight secondary ion mass spectrometry more and more material from the coating is removed from top to bottom, hence, over time material from deeper depths of the coating is analyzed. As the person skilled in the art knows, ToF-SIMS measurements provide relative results but no absolute ones. Hence, ToF-SIMS provides relative values for the trace element contents. Optionally, a certain numerical value is assigned to a certain TOF-SIMS signal strength. For example, if a signal strength of x is measured to which the value 0.75 is assigned, then the value 1.5 is assigned to a measured signal strength of 2×. IONTOF: TOF-SIMS IV can for example be used as measuring device for performing the ToF-SIMS analysis.

The values in this way are optionally normalized relative to a certain element. In particular, in the ToF-SIMS analyses described hereinafter, the values can be normalized relative to the 30Si-isotope. Thus, on the vertical axis of a ToF-SIMS analysis a respective measurement result with reference to a reference element, such as 30Si-isotope, is shown.

ToF-SIMS can be used to determine the signal strengths at least for carbon, hydrogen, nitrogen, fluorine, oxygen and/or chlorine.

ToF-SIMS can be applied based on the standards ASTM E 1829-14 (as of 2014) and ASTM E 2695-09 (as of 2009).

In particular, ToF-SIMS can be performed with the following analysis and sputter parameters:

Analysis Parameters:

| PI: | Ga | |
|---|---|---|
| Energy: | 25 | keV |
| Current: | 1 | pA |
| Area: | 50 × 50 | μm² |

| | |
|---|---|
| PIDD: | Ions/cm² |

Sputter Parameters:

| SpI: | optionally Cs or alternatively O₂ | |
|---|---|---|
| Energy: | 0.5 to 2 keV, optionally 1 keV | |
| Current: | 95 | nA |
| Area: | 300 × 300 | μm² |

| | |
|---|---|
| PIDD: | Ions/cm² |

According to some embodiments of the coating, when measuring the carbon content by a ToF-SIMS analysis with Ga at 25 keV (optionally the above identified analysis parameters) and the measurement results are normalized relative to 30Si-isotope, for a ratio R between a carbon content C₀ at a sputter time T₀ and a carbon content C₁ at a sputter time T₁ (T₁=T₀+3500 s), in particular within the at least one silicon layer, the following condition can apply:

$$R = \frac{{C}_{0} ( {T}_{0} )}{{C}_{1} ( {T}_{1} )} = \frac{{C}_{0} ( {T}_{0} )}{{C}_{1} ( {T}_{0} + 3500 [ s ] )} \geq 1.2 ,$$

$$optionally \geq 1.4 ,$$

$$optionally \geq 1.5 .$$

The condition relates to carbon content change within the coating. I.e. the compared measurement points at T₀ and T₁ are measurement points within the coating—not in the substrate. More precisely, the condition can relate to carbon content change within the at least one silicon layer of the coating. In this case, the compared measurement points at T₀ and T₁ are measurement points within the same silicon layer.

The multilayer coating can comprise a plurality of silicon layers, optionally at least two silicon layers, optionally at least four silicon layers, optionally at least five silicon layers, and further comprises at least one silicon dioxide layer, optionally at least two silicon dioxide layers, optionally at least four silicon dioxide layers, optionally at least five silicon dioxide layers. The silicon layers and the silicon dioxide layers can be configured in an alternating arrangement. A silicon dioxide layer may comprise more than 70 mol %, or more than 90 mol % of SiO₂.

The conditions specified herein can apply for one of the plurality of silicon layers or for several of the plurality of silicon layers of the multilayer coating. The conditions specified herein do not necessarily apply for each of the plurality of silicon layers of the multilayer coating. In particular, in some multilayer coatings, only individual (or even only one single) layers can have a thickness as mentioned in the context of the specified conditions and/or that allows measurements with a sputter time delta of 3500 s.

The at least one silicon layer can be a hydrogenated silicon layer (Si:H), optionally a hydrogenated amorphous silicon layer (a-Si:H).

Referring to a hydrogenated silicon layer that has been deposited without supplementing additional hydrogen gas during deposition of the hydrogenated silicon layer during the CVD process, the changing refractive index of the at least one hydrogenated silicon layer (changing over the layer thickness of the at least one silicon layer) for light with a wavelength between 780 nm and 3 μm, optionally between 900 nm and 2 μm, such as for light at 905 nm and/or 1550 nm can be between 2.7 and 4.0, optionally between 2.85 and 3.9. At any point within the at least one hydrogenated silicon layer the measured refractive index relating to these wavelengths can be at least 2.7, optionally at least 2.85. At any point within the at least one hydrogenated silicon layer the measured refractive index can be 4.0 or less, optionally 3.9 or less.

Referring to a hydrogenated silicon layer that has been deposited with supplementing additional hydrogen gas during deposition of the hydrogenated silicon layer during the CVD process, the changing refractive index of the at least one hydrogenated silicon layer (changing over the layer thickness of the at least one silicon layer) for light with a wavelength between 780 nm and 3 μm, optionally between 900 nm and 2 μm, such as for light at 905 nm and/or 1550 nm can be between 2.25 and 3.9, optionally between 2.4 and 3.85. At any point within the at least one hydrogenated silicon layer the measured refractive index can be at least 2.25, optionally at least 2.4. At any point within the at least one hydrogenated silicon layer the measured refractive index can be 3.9 or less, optionally 3.85 or less.

In some embodiments, the coating can have an average transmission for light with wavelengths between 400 nm and 700 nm of less than 10%, optionally less than 7.5%, optionally less than 5%. In other words, the coating can be substantially opaque for visible light, i.e. VIS-absorptive. The coating can have an average transmission for light with wavelengths between 780 nm and 3 μm, optionally between 900 nm and 2 μm, such as for light at 905 nm and/or 1550 nm, of at least 90%, optionally at least 92%, optionally between 92% und 94%. In other words, the coating can be substantially transparent for light in the near infrared spectral range, i.e. for NIR-light.

The coating can have a cumulative thickness between 100 nm and 5000 nm, optionally between 200 nm and 1000 nm, optionally between 2000 nm and 3000 nm.

The at least one silicon layer can have a layer thickness between 1 nm and 2000 nm, optionally between 2 nm and 1100 nm, optionally between 1500 nm and 3000 nm.

The coating can comprise a total number of one to twelve silicon layers and one to twelve silicon dioxide layers, optionally with the same number of silicon layers and silicon dioxide layers. In particular, the coating can comprise four silicon layers and four silicon dioxide layers, optionally eight silicon layers and eight silicon dioxide layers, optionally ten silicon layers and ten silicon dioxide layers.

Each of the silicon layers of the coating can have a layer thickness between 1 nm and 2000 nm, optionally between 1.5 nm and 1500 nm, optionally between 2 nm and 1100 nm. The silicon layers can have different thicknesses, depending on the intended application of the coating.

In some embodiments, the at least one silicon layer can have a hydrogen content gradient over its layer thickness. In other words, the at least one silicon layer can have a differing distribution of hydrogen element traces over its thickness, its amount of hydrogen traces can have a gradient through the silicon layer with respect to the layer thickness.

The at least one silicon layer can comprise a thickness section of 50 nm over which the hydrogen content decreases at least 0.05%, optionally at least 0.5%, optionally at least 2.5% viewed in a direction away from the glass substrate. The hydrogen content can decrease between 0.05% and 2.5% over the thickness section.

The at least one silicon layer can comprise a thickness section of 30 nm over which the hydrogen content decreases at least 0.025%, optionally at least 0.25%, optionally at least 1.5% viewed in a direction away from the glass substrate. The hydrogen content can decrease between 0.025% and 1.5% over the thickness section.

The at least one silicon layer can comprise a thickness section of 100 nm over which the hydrogen content decreases at least 0.1%, optionally at least 1%, optionally at least 4% viewed in a direction away from the glass substrate. The hydrogen content can decrease between 0.1% and 4% over the thickness section.

When measuring the hydrogen content by a ToF-SIMS analysis with Ga at 25 keV (optionally the above identified analysis parameters) and normalizing the measurement results relative to 30Si-isotope, for a ratio R between a hydrogen content H₀ at a sputter time T₀ and a hydrogen content H₁ at a sputter time T₁ (T₁=T₀+3500 s), in particular within the at least one silicon layer, the following condition can apply:

$$R = \frac{{H}_{0} ( {T}_{0} )}{{H}_{1} ( {T}_{1} )} = \frac{{H}_{0} ( {T}_{0} )}{{H}_{1} ( {T}_{0} + 3500 [ s ] )} \leq 1. ,$$

$$optionally R \leq 0.7 ,$$

$$optionally 0.1 \leq R . \leq 0. 7 .$$

In some embodiments, the at least one silicon layer can have a fluorine content gradient over its layer thickness. In other words, the at least one silicon layer can have a differing distribution of fluorine element traces over its thickness, its amount of fluorine traces can have a gradient through the silicon layer with respect to the layer thickness. The fluorine content gradient can be relatively small compared to gradients of other element traces.

The at least one silicon layer can comprise a thickness section of 50 nm over which the fluorine content changes at least 0.05%, optionally at least 0.5%, optionally at least 1.5%, referring to an absolute value of the content gradient. The fluorine content can change between 0.05% and 1.5% over the thickness section.

The at least one silicon layer can comprise a thickness section of 30 nm over which the fluorine content changes at least 0.025%, optionally at least 0.25%, optionally at least 1.0% referring to an absolute value of the content gradient. The fluorine content can change between 0.025% and 1.0% over the thickness section.

The at least one silicon layer can comprise a thickness section of 100 nm over which the fluorine content changes at least 0.1%, optionally at least 1%, optionally at least 3% referring to an absolute value of the content gradient. The fluorine content can change between 0.1% and 4% over the thickness section.

When measuring the fluorine content by a ToF-SIMS analysis with Ga at 25 keV (optionally the above identified analysis parameters) and normalizing the measurement results relative to 30Si-isotope, for a ratio R between a fluorine content F₀ at a sputter time T₀ and a fluorine content F₁ at a sputter time T₁ (T₁=T₀+3500 s), in particular within the at least one silicon layer, the following condition can apply:

$$R = \vert \frac{{F}_{0} ( {T}_{0} )}{{F}_{1} ( {T}_{1} )} \vert = \vert \frac{{F}_{0} ( {T}_{0} )}{{F}_{1} ( {T}_{0} + 3500 [ s ] )} \vert \geq 0.7 ,$$

$$optionally R \geq 1. ,$$

$$optionally 1. 5 \geq R \geq 1.$$

In some embodiments, the at least one silicon layer can have a nitrogen content gradient over its layer thickness. In other words, the at least one silicon layer can have a differing distribution of nitrogen element traces over its thickness, its amount of nitrogen traces can have a gradient through the silicon layer with respect to the layer thickness.

The at least one silicon layer can comprise a thickness section of 50 nm over which the nitrogen content decreases at least 0.2%, optionally at least 2%, optionally at least 6% viewed in a direction away from the glass substrate. The nitrogen content can decrease between 0.2% and 6% over the thickness section.

The at least one silicon layer can comprise a thickness section of 30 nm over which the nitrogen content decreases at least 0.15%, optionally at least 1.5%, optionally at least 5% viewed in a direction away from the glass substrate. The nitrogen content can decrease between 0.15% and 5% over the thickness section.

The at least one silicon layer can comprise a thickness section of 100 nm over which the nitrogen content decreases at least 0.4%, optionally at least 3%, optionally at least 6% viewed in a direction away from the glass substrate. The nitrogen content can decrease between 0.4% and 6% over the thickness section.

When measuring the nitrogen content by a ToF-SIMS analysis with Ga at 25 keV (optionally the above identified analysis parameters) and normalizing the measurement results relative to 30Si-isotope, for a ratio R between a nitrogen content No at a sputter time T₀ and a nitrogen content N₁ at a sputter time T₁ (T₁=T₀+3500 s), in particular within the at least one silicon layer, the following condition can apply:

$$R = \frac{{N}_{0} ( {T}_{0} )}{{N}_{1} ( {T}_{1} )} = \frac{{N}_{0} ( {T}_{0} )}{{N}_{1} ( {T}_{0} + 3500 [ s ] )} \leq 0 \text{.9} ,$$

$$optionally \leq 0.6 ,$$

$$optionally 0.1 \leq R \leq 0.6 .$$

For example, the nitrogen content, i.e. the nitrogen content change, can be determined by measuring silicon nitride content.

In some embodiments, the at least one silicon layer can have a chlorine content gradient over its layer thickness. In other words, the at least one silicon layer can have a differing distribution of chlorine element traces over its thickness, its amount of chlorine traces can have a gradient through the silicon layer with respect to the layer thickness. The chlorine content gradient can be relatively small compared to gradients of other element traces.

The at least one silicon layer can comprise a thickness section of 50 nm over which the chlorine content changes at least 0.03%, optionally at least 0.4%, optionally at least 2%, referring to an absolute value of the content gradient. The chlorine content can change between 0.03% and 2% over the thickness section.

The at least one silicon layer can comprise a thickness section of 30 nm over which the chlorine content changes at least 0.02%, optionally at least 0.35%, optionally at least 1.75%, referring to an absolute value of the content gradient. The chlorine content can change between 0.02% and 1.75% over the thickness section.

The at least one silicon layer can comprise a thickness section of 100 nm over which the chlorine content changes at least 0.06%, optionally at least 0.8%, optionally at least 4%, referring to an absolute value of the content gradient. The chlorine content can change between 0.06% and 4% over the thickness section.

When measuring the chlorine content by a ToF-SIMS analysis with Ga at 25 keV (optionally the above identified analysis parameters) and normalizing the measurement results relative to 30Si-isotope, for a ratio R between a chlorine content Cl₀ at a sputter time T₀ and a chlorine content Cl₁ at a sputter time T₁ (T₁=T₀+3500 s), in particular within the at least one silicon layer, the following condition can apply:

$$R = \vert \frac{{Cl}_{0} ( {T}_{0} )}{{Cl}_{1} ( {T}_{1} )} \vert = \vert \frac{{Cl}_{0} ( {T}_{0} )}{{Cl}_{1} ( {T}_{0} + 3500 [ s ] )} \vert \geq 0.7 ,$$

$$optionally \geq 1. ,$$

$$optionally 1. 4 \geq R \geq 1. .$$

In some embodiments, the at least one silicon layer can have an oxygen content gradient over its layer thickness. In other words, the at least one silicon layer can have a differing distribution of oxygen element traces over its thickness, its amount of oxygen traces can have a gradient through the silicon layer with respect to the layer thickness.

The at least one silicon layer can comprise a thickness section of 50 nm over which the oxygen content changes at least 0.07%, optionally at least 0.7%, optionally at least 3%, referring to an absolute value of the content gradient. The oxygen content can change between 0.07% and 3% over the thickness section.

The at least one silicon layer can comprise a thickness section of 30 nm over which the oxygen content changes at least 0.06%, optionally at least 0.6%, optionally at least 2.5%, referring to an absolute value of the content gradient. The oxygen content can change between 0.06% and 2.5% over the thickness section.

The at least one silicon layer can comprise a thickness section of 100 nm over which the oxygen content changes at least 0.14%, optionally at least 1.4%, optionally at least 4.5%, referring to an absolute value of the content gradient. The oxygen content can change between 0.14% and 4.5% over the thickness section.

When measuring the oxygen content by a ToF-SIMS analysis with Ga at 25 keV (optionally the above identified analysis parameters) and normalizing the measurement results relative to 30Si-isotope, for a ratio R between an oxygen content O2₀ at a sputter time T₀ and an oxygen content O2₁ at a sputter time T₁ (T₁=T₀+3500 s), in particular within the at least one silicon layer, the following condition applies:

$$R = \vert \frac{O {2}_{0} ( {T}_{0} )}{O {2}_{1} ( {T}_{1} )} \vert = \vert \frac{O {2}_{0} ( {T}_{0} )}{O {2}_{1} ( {T}_{0} + 3500 [ s ] )} \vert \geq 1.2$$

$$optionally \geq 1.5$$

$$optionally 1. 7 \geq R \geq 1.5 .$$

Another aspect of the invention relates to a glass substrate having at least one surface portion that is provided with a coating of the type described above. The glass substrate can comprise further coatings of the same type and/or of a different type.

In some embodiments, the at least one surface portion of the glass substrate can have a curved shape. Optionally, the glass substrate can be a ring or ring segment. The glass substrate can be a cone, a cylinder, a tube or the like. The surface portion coated with the described coating can be an inner circumferential surface or inner circumferential surface portion of the glass substrate.

In some embodiments, the glass substrate comprises silicate glass, borosilicate glass or aluminosilicate glass.

Another aspect of the invention relates to a glass window, in particular to a glass window for a LiDAR system. The glass window comprises a coating of the type described above and/or a glass substrate according to of the type described above. The glass window can be suitable for a protective housing for a LiDAR system. The coating and/or glass substrate can also be used for multiple other applications and is not limited to use as glass windows/in LiDAR systems.

Another aspect of the invention relates to a method for producing a coating on a substrate, in particular for producing a coating of the type described above. The method comprises at least the steps of:
providing the substrate in a vacuum chamber;
depositing at least one layer to the substrate by a chemical vapor deposition method (CVD), optionally by a plasma impulse chemical vapor deposition method (PICVD), wherein the at least one layer is a silicon layer having a carbon content gradient over its layer thickness.

Depositing at least one layer to the substrate by a chemical vapor deposition method (CVD), in particular by a plasma impulse chemical vapor deposition method (PICVD), creates the carbon content gradient within the at least one silicon layer. Namely, during the depositing step chemical reactions can occur. Optionally, trace amounts of carbon, hydrogen, nitrogen, fluorine, nitrogen, oxygen and/or chlorine present in the atmosphere of (i.e. inside) the vacuum chamber and/or present on the surface of the substrate to be coated can be incorporated into the coating. This results in a compositional and optical gradient, in particular the carbon content gradient, over the layer thickness of the deposited coating.

The substrate can be a glass substrate, optionally of the type described above.

The substrate can be curved. Optionally, the substrate can be optionally a ring or ring segment. The glass substrate can be a cone, a cylinder, a tube or the like. Optionally, a surface portion of an inner circumferential surface or an inner circumferential surface portion of the glass substrate can be coated in the method. In other words, the at least one layer can be deposited on a surface portion of an inner circumferential surface or an inner circumferential surface portion of the curved glass substrate. The curved surface to be coated can thus be used as a wall of the vacuum chamber. Chemical vapor deposition can help to achieve a uniform coating on curved surfaces, in contrast to e.g. sputtering. Further, using chemical vapor deposition for producing the coating allows a faster production of the coating compared to laser-based methods, such as sputtering. For example, interference coatings comprising multiple layers can be produced in a short time span of only a few minutes. More precisely, a coating rate of 10 to 15 nm/s for Si:H and a coating rate of 5 to 10 nm/s for SiO₂ can be used. Thus, a multilayer of total thickness of 2.5 μm (2 μm Si+0.5 μm SiO₂) can take less than 8 minutes, optionally approx. 7 minutes.

The PICVD parameters can be maintained constant during the depositing step. In particular, the PICVD can be performed without changing the pulse parameters during the process.

Argon can be used as plasma gas of the PICVD process for depositing the at least one silicon layer.

For depositing the at least one silicon layer silane (SiH₄) gas can be used as reacting gas, i.e. as layer-forming gas. Using silane (SiH₄) gas as precursor can be advantageous to incorporate trace amounts of carbon, hydrogen, nitrogen, fluorine, oxygen and/or chlorine into the coating, more precisely the deposited layer, during the depositing step.

The silicon layer can be hydrogenated during the depositing step by supplying hydrogen gas into the vacuum chamber. The carbon content gradient can be tailored or adjusted by adapting the quantity of the additional hydrogen gas introduced during the depositing step. Thus, supplying hydrogen can be controlled in order to optimize the refractive index gradient. In particular, by increasing the amount of additional hydrogen gas (as reducing gas), the carbon content in the coating can be decreased.

In some embodiments of the PICVD process, a pressure between 0.05 mbar and 10 mbar, optionally between 0.1 mbar and 5 mbar, optionally between 1 mbar and 4 mbar, can be applied to the vacuum chamber. Applying this pressure helps to form the carbon content gradient and thus the intended refractive index gradient in the at least one silicon layer.

In some embodiments of the PICVD process, a temperature between 24° C. and 400° C. can be set, optionally between 200° C. and 375° C., in particular at 375° C.

The method, more precisely the PICVD process, can comprise an Ar-plasma pretreatment. The Ar-plasma pretreatment can be carried out for 10 s to 50 s, optionally 20 s to 40 s, optionally 30 s. A nominal output can be between 3000 W and 6000 W, optionally 5000 W. A pulse duration can be between 1 ms and 10 ms, optionally between 2 ms and 6 ms, optionally 4 ms, and a pulse pause can be between 10 ms and 100 ms, optionally between 25 ms and 75 ms, optionally 50 ms. A control pressure can be between 1 mbar and 8 mbar, optionally between 2 mbar and 5 mbar, optionally 3 mbar. An Ar flow can be between 50 sccm and 500 sccm, optionally between 100 sccm and 300 sccm, optionally 200 sccm (cm³/min).

For depositing silicon layers with a carbon content gradient in a multiple layer coating, the method, more precisely the PICVD process, can be carried out with one or more of the following parameters:
a nominal output can be between 2500 W and 7500 W, optionally between 3500 W and 6500 W, optionally 5000 W;
a pulse duration can be between 2 ms and 8 ms, optionally between 3 ms and 7 ms, optionally between 4 ms and 6 ms, still optionally 5 ms, and a pulse pause can be between 50 ms and 150 ms, optionally between 75 ms and 125 ms, optionally between 85 ms and 115 ms, still optionally 100 ms;
a control pressure can be between 0.5 mbar and 1.5 mbar, optionally between 0.75 and 1.25 mbar, optionally 1.0 mbar;
a gas flow of 1% SiH₄ in He can be between 200 sccm and 600 sccm, optionally between 300 sccm and 500 sccm, optionally 400 sccm (cm³/min);
a gas flow of Ar can be between 100 sscm and 300 sscm, optionally between 150 sscm and 250 sscm, optionally 200 sccm (cm³/min).

By this, a silicon layer with a thickness between 50 nm and 100 nm can be deposited.

For depositing silicon dioxide layers in a multiple layer coating, the method, more precisely the PICVD process, can be carried out with one or more of the following parameters:
a nominal output can be between 2000 W and 6000 W, optionally between 3000 W and 5000 W, optionally 4000 W;
a pulse duration can be between 2 ms and 8 ms, optionally between 4 ms and 6 ms, optionally 5 ms, and a pulse pause can be between 25 ms and 75 ms, optionally between 40 ms and 60 ms, optionally 50 ms;
a control pressure can be between 0.2 mbar and 0.6 mbar, optionally between 0.3 mbar and 0.5 mbar, optionally 0.4 mbar;
a gas flow of HMDSO (hexamethyldisiloxane) can be between 10 sccm and 40 sccm, optionally between 20 sccm and 30 sccm, optionally 25 sccm (cm³/min);
a gas flow of O₂ can be between 250 sscm and 500 sccm, optionally between 325 sccm and 425 sccm, optionally 375 sccm (cm³/min).

Even though some of the features, functions, embodiments, technical effects and advantages have been described with regard to the coating, the glass substrate, the glass window or the method for producing a coating, it will be understood that these features, functions, embodiments, technical effects and advantages can also apply accordingly to the method for producing a coating, the glass window, the glass substrate and/or the coating. Particularly, all exemplary embodiments for the coating apply also for the method for producing a coating and the other way around unless specified otherwise.

Various examples of embodiments provided according to the present invention will be explained in more detail by virtue of the following embodiments illustrated in the figures and/or described below.

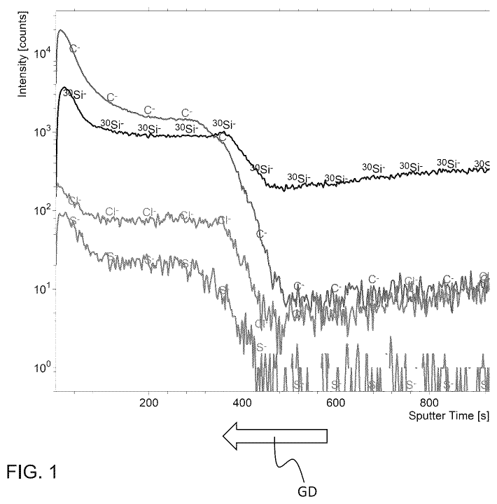

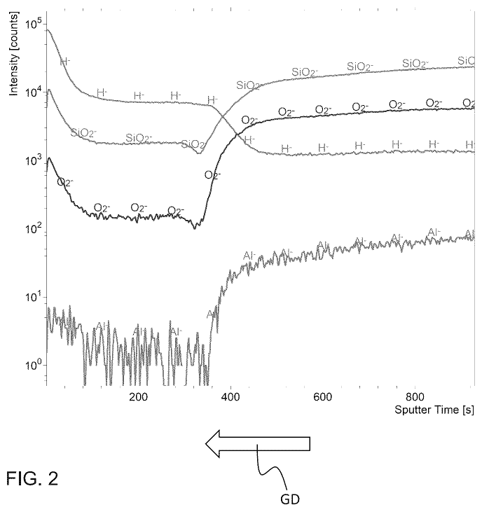

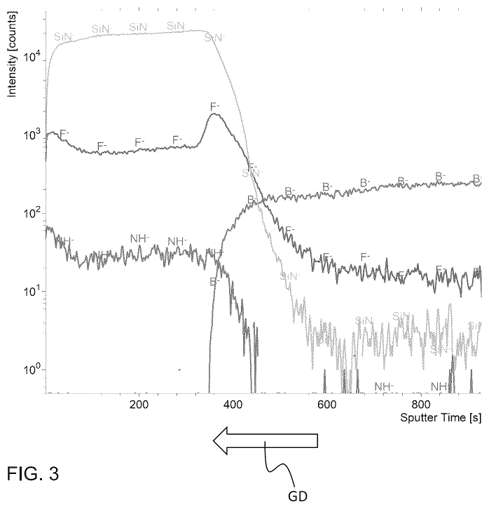

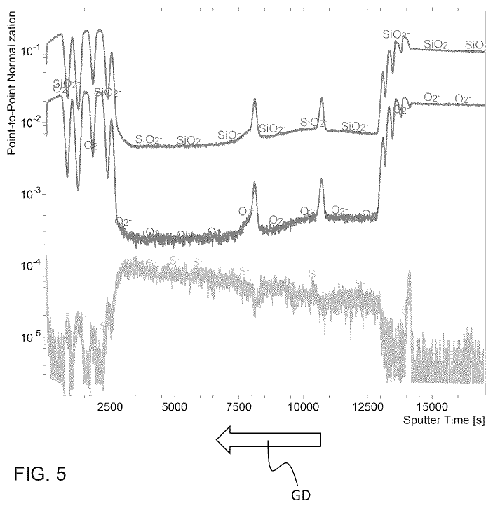

The qualitative measurement results shown in FIGS. 1 to 12 have been obtained by a ToF-SIMS analysis based on the standards ASTM E 1829-14 (as of 2014) and ASTM E 2695-09 (as of 2009) and under application of the following analysis and sputter parameters:

Analysis Parameters:

| PI: | Ga | |
|---|---|---|
| Energy: | 25 | keV |
| Current: | 1 | pA |
| Area: | 50 × 50 | μm² |

| | |
|---|---|
| PIDD: | Ions/cm² |

Sputter Parameters:

| SpI: | Cs | |
|---|---|---|
| Energy: | 1 | keV |
| Current: | 95 | nA |
| Area: | 300 × 300 | μm² |

| | |
|---|---|
| PIDD: | Ions/cm² |

IONTOF: TOF-SIMS IV has been used as measuring device for performing the ToF-SIMS analysis.

In the diagrams of FIGS. 1 to 12, the vertical axis shows the intensity [counts] of the measured contents of trace elements. The horizontal axis shows the sputter time of the ToF-SIMS process, starting at 0 s from an outer surface (interface between coating and air) and continues with increasing time in a direction towards the glass substrate. With increasing time more and more material from the coating is removed from top to bottom, hence, over time material from deeper depths of the coating is analyzed. It is noted that as indicated by arrows GD, a layer or coating growth direction starting from the substrate is opposite to the increasing sputter time (as the sputter time of the ToF-SIMS analysis does not constitute a sputter time of a depositing process).

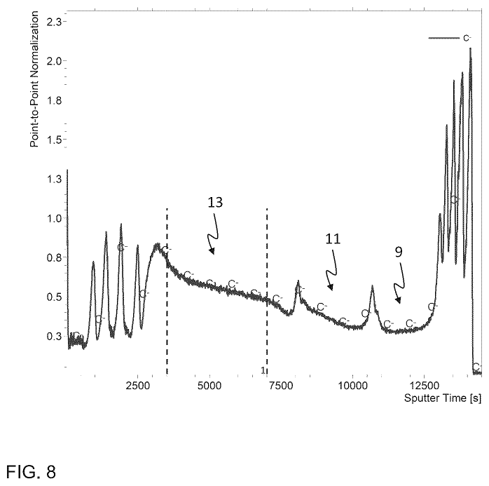

FIGS. 8 to 12 show diagrams in which the measurement results have been normalized relative to measured 30Si-isotope.

FIGS. 1 to 3 show results of a respective ToF-SIMS analysis of one silicon layer, i.e. of a single or monolayer, of a coating provided according to the invention and a portion of the glass substrate on which the coating is deposited. The interface between the coating and the substrate can be seen between 360 s and 440 s. The analyzed silicon layer is a hydrogenated silicon layer. The diagrams of FIGS. 1 to 3 show qualitative contents of hydrogen H, boron B, carbon C, fluorine F, aluminum Al, 30Si-isotope, sulfur S, chlorine Cl, silicon nitride SiN, silicon dioxide SiO₂, NH, and oxygen O₂ over a sputter time of approx. 860 seconds. SiN and NH represent the nitrogen content within the coating. For better overview, the graphs of the measured elements are distributed over diagrams 1 to 3 instead of showing them in one single diagram.

The analyzed silicon layer has a layer thickness of approx. 100 nm. As can be seen in FIGS. 1 to 3, the contents of each of hydrogen H, carbon C, fluorine F, aluminum Al, sulfur S, chlorine Cl, nitrogen, silicon dioxide SiO₂, and oxygen O₂ changes over the layer thickness. Hence, the silicon layer comprises content gradients of trace amounts of these elements.

The analyzed silicon layer of FIGS. 1 to 3 has a refractive index n of 3.1 at a distance of 18 nm from the glass substrate, a refractive index n of 3.05 at a distance of 36 nm from the glass substrate, a refractive index n of 3.0 at a distance of 55 nm from the glass substrate, a refractive index n of 2.94 at a distance of 73 nm from the glass substrate, and a refractive index n of 3.1 at a distance of 91 nm from the glass substrate. Hence, the silicon layer has a refractive index gradient over its layer thickness.

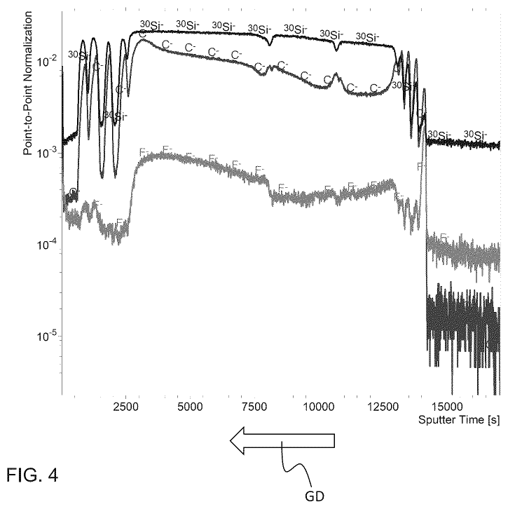

FIGS. 4 to 6 shows results of a respective ToF-SIMS analysis of a coating deposited on a borosilicate glass. The coating comprises 24 layers including twelve hydrogenated silicon layers and twelve silicon dioxide layers. The hydrogenated silicon layers and the silicon dioxide layers are configured in an alternating arrangement.

The coating of FIGS. 4 to 6, i.e. the 24 single layers, have been deposited by a plasma impulse chemical vapor deposition process (PICVD) with hexamethyldisiloxane (HMDSO) as precursor and O₂ as plasma gas for depositing the silicon dioxide layers and silan as precursor and argon as plasma gas for depositing the silicon layers. The PICVD parameters have been maintained constant during the depositing step. In particular, the pulse parameters were not changed during depositing. The silicon layer has been hydrogenated by supplying hydrogen gas into the vacuum chamber during depositing of the silicon layer.

More precisely, the applied PICVD method included an Ar-plasma pretreatment. The Ar-plasma pretreatment was carried out for 30 s with a nominal output of 5000 W. The applies pulse duration was 4 ms, and the pulse pause 50 ms. A control pressure was set to 3 mbar. The Ar flow was 200 sccm (cm³/min).

At least the analyzed silicon layer of the coating was deposited by carrying out the PICVD process with the following parameters:
a nominal output can be 5000 W;
a pulse duration can be 5 ms and a pulse pause can be 100 ms;
a control pressure can be 1.0 mbar;
a gas flow of 1% SiH₄ in He can be 400 sccm (cm³/min); and
a gas flow of Ar can be 200 sccm (cm³/min).

At least one of the silicon dioxide layers within the coating was deposited by carrying out the PICVD process with the following parameters:
a nominal output can be 4000 W;
a pulse duration can be 5 ms and a pulse pause can be 50 ms;
a control pressure can be 0.4 mbar;
a gas flow of HMDSO (hexamethyldisiloxane) can be 25 sccm (cm³/min); and
a gas flow of O₂ can be 375 sccm (cm³/min).

Table 1 shows the individual layer thicknesses of the coating of FIGS. 4 to 6:

TABLE 1

| Layer | Material | Thickness (nm) |
|---|---|---|
| | GLASS | |
| 1 | Si:H | 2.21 |
| 2 | SiO₂ | 50.86 |
| 3 | Si:H | 6.99 |
| 4 | SiO₂ | 41.62 |
| 5 | Si:H | 14.73 |
| 6 | SiO₂ | 28.43 |
| 7 | Si:H | 25.72 |
| 8 | SiO₂ | 12.19 |
| 9 | Si:H | 458.11 |
| 10 | SiO₂ | 4 |
| 11 | Si:H | 499.65 |
| 12 | SiO₂ | 4 |
| 13 | Si:H | 1059.78 |
| 14 | SiO₂ | 22.7 |
| 15 | Si:H | 37.54 |
| 16 | SiO₂ | 76.09 |
| 17 | Si:H | 24.87 |
| 18 | SiO₂ | 73.73 |
| 19 | Si:H | 47.42 |
| 20 | SiO₂ | 37.01 |
| 21 | Si:H | 38.74 |
| 22 | SiO₂ | 124.91 |
| 23 | Si:H | 3.31 |
| 24 | SiO₂ | 3.79 |
| | AIR | |

FIGS. 4 to 6 show qualitative measurement results of trace amounts of carbon C, fluorine F, 30Si-isotope, sulfur S, oxygen O₂, silicon dioxide SiO₂, silicon carbide SiC, and nitrogen. For better overview, the graphs of the measured trace amounts of different elements are distributed over diagrams 4 to 6 instead of showing them in one single diagram. As can be seen from FIGS. 4 to 6, the amount of at least carbon C, fluorine F, sulfur S, oxygen O₂, silicon dioxide SiO₂, silicon carbide SiC, and nitrogen changes within each of the silicon layers (i.e. over each layer thickness). Hence, each of the silicon layers comprises content gradients of trace amounts of these elements, which results in refractive index gradients within each silicon layer and thus within the coating. It is derivable from FIGS. 4 to 6 that the interface between the coating and the borosilicate glass substrate is detected at a sputter time of approx. 14750 s. The measuring results on the left hand side of this interface, i.e. at sputter times between 0 s and approx. 14750 s relate to the coating.

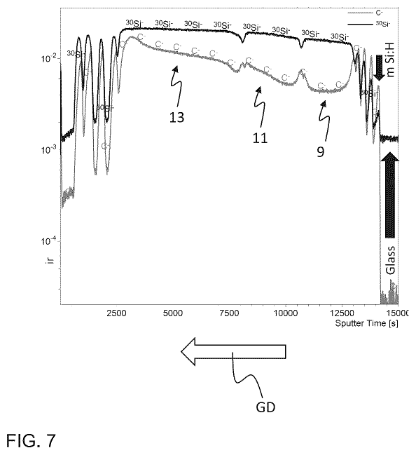

FIG. 7 shows the measuring results of FIG. 4 only for carbon and 30Si-isotope isolated from the other measuring results of FIG. 4. As can be seen in particular with regard to the silicon layers with a layer thickness of more than 400 nm, the content of 30Si-isotope is substantially constant. Hence, the 30Si-isotope is suitable for normalizing the measurement results of relevant elements relative to the 30Si-isotope (as shown in FIGS. 8 to 12). With regard to Table 1, silicon layer 9 with a layer thickness of 458.11 is indicated by reference sign 9, silicon layer 11 with a layer thickness of 499.65 is indicated by reference sign 11, and silicon layer 13 with a layer thickness of 1059.78 is indicated by reference sign 13.

In the diagrams of FIGS. 8 to 12, local maxima (disregarding the noise of the measurement results) usually indicate the beginning of a new silicon layer. The region around local minima (also disregarding the noise of the measurement results) indicate respective silicon dioxide layers between two silicon layers. It is noted that silicon dioxide layers do not contain any carbon hydrogen, fluorine, nitrogen, or chlorine trace amounts. The reason why the measurement values shown in the diagrams do not always show the value 0 is that the diagrams show interpolated curves.

FIG. 8 shows the measurement results of FIG. 4 for carbon content normalized relative to the 30Si-isotope. The diagram of FIG. 8 clearly shows the carbon content gradient within each of the silicon layers, in particular in silicon layers 9, 11 and 13. As indicated in FIG. 8, in silicon layer 13 a ratio R between a carbon content C₀ at a sputter time T₀ and a carbon content C₁ at a sputter time T₁, wherein T₁=T₀+3500 s, the following condition applies:

$$R = \frac{{C}_{0} ( {T}_{0} )}{{C}_{1} ( {T}_{1} )} \approx \frac{0.8}{0.5} = 1.6 .$$

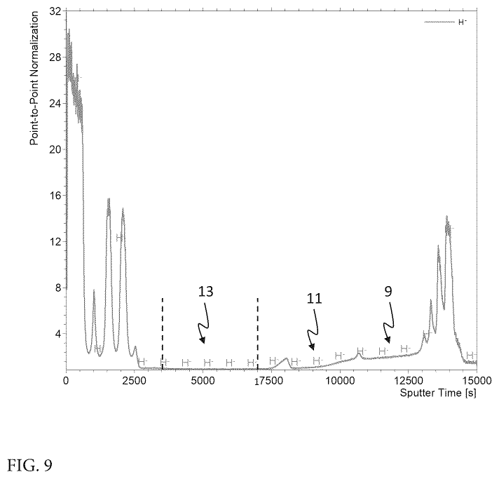

FIG. 9 shows further measurement results for hydrogen content in the same coating of FIG. 4 (even though not shown in FIG. 4) normalized relative to the 30Si-isotope. As indicated in FIG. 9, in silicon layer 13 a ratio R between a hydrogen content H₀ at a sputter time T₀ and a hydrogen content H₁ at a sputter time T₁, wherein T₁=T₀+3500 s, the following condition applies:

$$R = \frac{{H}_{0} ( {T}_{0} )}{{H}_{1} ( {T}_{1} )} \approx \frac{0.02}{0.02} = 1. .$$

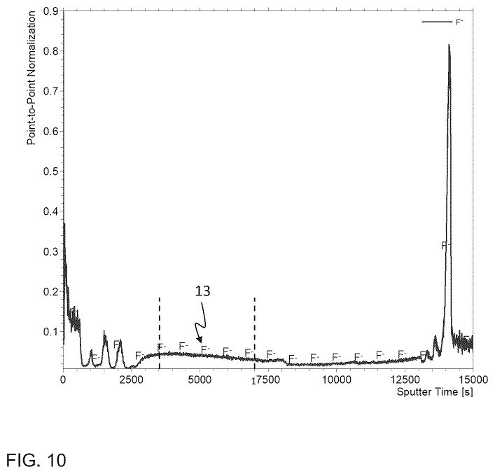

FIG. 10 shows the measurement results of FIG. 4 for fluorine content normalized relative to the 30Si-isotope. As indicated in FIG. 10, in silicon layer 13 a ratio R between a fluorine content F₀ at a sputter time T₀ and a fluorine content F₁ at a sputter time T₁, wherein T₁=T₀+3500 s, the following condition applies:

$$R = \vert \frac{{F}_{0} ( {T}_{0} )}{{F}_{1} ( {T}_{1} )} \vert \approx \frac{0.04}{0.028} = 1.43 .$$

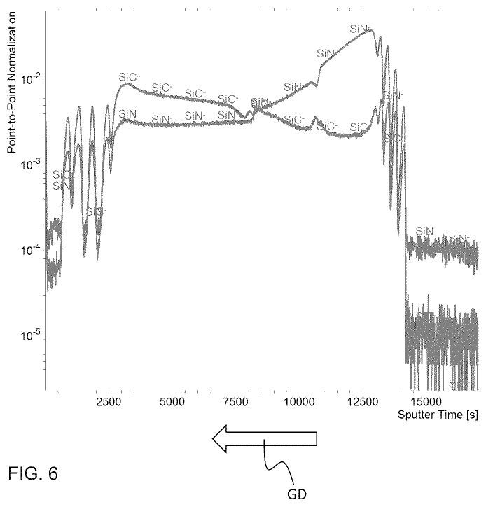

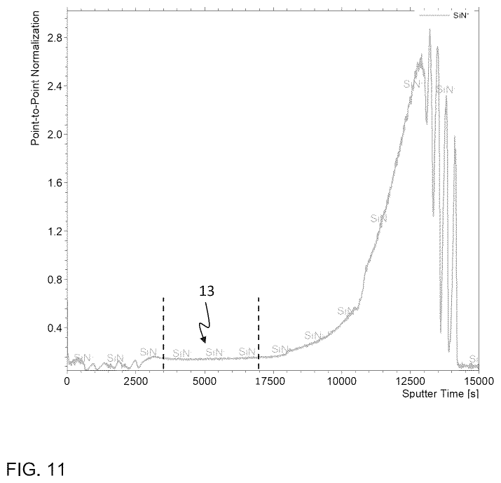

FIG. 11 shows the measurement results of FIG. 6 for nitrogen content normalized relative to the 30Si-isotope (based on silicon nitride). As indicated in FIG. 11, in silicon layer 13 a ratio R between a nitrogen content No at a sputter time T₀ and a nitrogen content N₁ at a sputter time T₁, wherein T₁=T₀+3500 s, the following condition applies:

$$R = \frac{{N}_{0} ( {T}_{0} )}{{N}_{1} ( {T}_{1} )} \approx \frac{0.09}{0.11} = 0.82 .$$

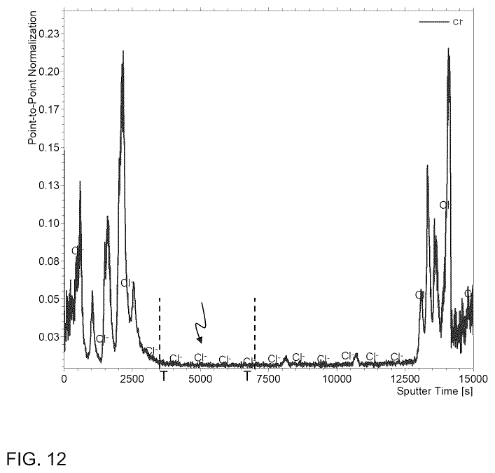

FIG. 12 shows further measurement results for chlorine content in the same coating of FIG. 4 (even though not shown in FIG. 4) normalized relative to the 30Si-isotope. As indicated in FIG. 12, in silicon layer 13 a ratio R between a chlorine content Cl₀ at a sputter time T₀ and a chlorine content Cl₁ at a sputter time T₁, wherein T₁=T₀+3500 s, the following condition applies:

$$R = \vert \frac{{Cl}_{0} ( {T}_{0} )}{{Cl}_{1} ( {T}_{1} )} \vert \approx \frac{0.006}{0.005} = 1.2 .$$

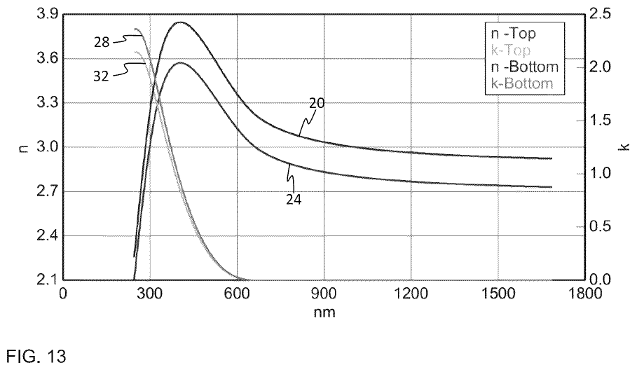

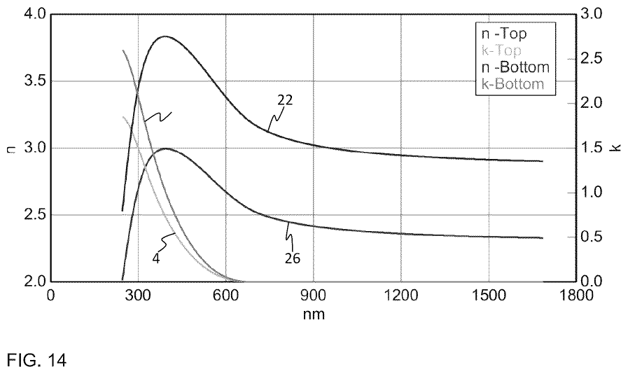

FIGS. 13 and 14 each show a refractive index n and an absorption coefficient k of a silicon layer, i.e. of a single layer of Si:H. The refractive index n and the absorption coefficient k were determined by ellipsometry. FIG. 13 shows a silicon layer, which has been deposited on a glass substrate without the addition of any additional gas during the depositing process. FIG. 14 shows a silicon layer, which has been deposited on a glass substrate with the addition of hydrogen as additional gas during the depositing process. In both figures, the upper solid curve 20, 22 represents the exposed external surface of the silicon layer, while the lower solid curve 24, 26 represents the glass side of the silicon layer, i.e. the surface facing and contacting the glass substrate. As can be seen from FIGS. 13 and 14, the refractive index gradient within the silicon coating is sharper (more distinct) in the silicon layer that has been deposited under the addition of hydrogen as additional gas during the depositing process (see FIG. 14).

The change in refractive index n in one single layer of Si:H occurs due to trace amounts of elements, in particular carbon, and optionally hydrogen, nitrogen, fluorine, nitrogen, oxygen and/or chlorine, contained within the silicon layer. The trace amounts are incorporated into the silicon layer by means of continuous surface reactions between the pulses of the PICVD process for applying the coating to the substrate. The refractive index gradient enables the provision of a suitable interference filter in the desired NIR range by using less stacking layers compared to a common multiple layer coating with layers each having a constant refractive index.

Moreover, as can also be seen in FIGS. 13 and 14 the absorption coefficient k is stable for light with wavelengths across the range 600 nm to 1500 nm for both silicon layers. Hence, the resulting stack (multiple layer coating) formed i.a. by silicon layers according to FIG. 13 or 14 can serve as an absorption filter for light with wavelengths in the UV-VIS spectrum. In both figures, the upper dashed curve 28, 30 represents the exposed external surface of the silicon layer, while the lower dashed curve 32, 34 represents the glass side of the silicon layer, i.e. the surface facing the glass substrate.

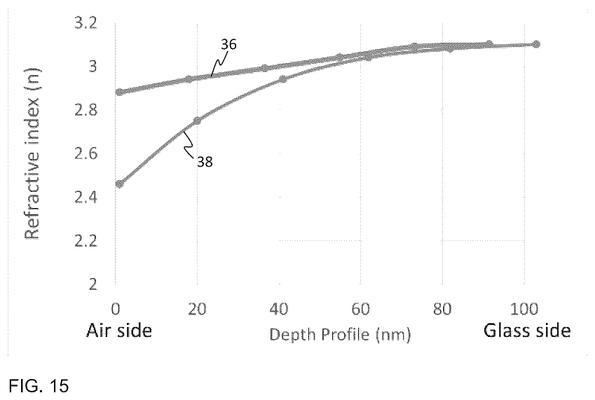

FIG. 15 shows the gradient in the refractive index n across 100 nm thick silicon layers, namely a silicon layer deposited without the addition of hydrogen gas (upper curve 36) and a silicon layer deposited under the addition of hydrogen gas (lower curve 38). FIG. 15 also shows that the refractive index gradient within the silicon layer is sharper (more distinct) in the silicon layer that has been deposited under the addition of hydrogen as additional gas during the depositing process. Hence, the gradient can be tailored through the supplied quantity of hydrogen.

Within the at least one silicon layer (Si:H) deposited without the addition of hydrogen gas the refractive index n for light with a wavelength of 782 nm increases over the layer thickness of 100 nm from approx. 2.9 to approx. 3.1. Thus, within the at least one silicon layer (Si:H) deposited with the addition of hydrogen gas the refractive index n for light with a wavelength of 782 nm increases over the layer thickness of 100 nm by more than 6%.

Within the at least one silicon layer (Si:H) deposited with the addition of hydrogen gas the refractive index n for light with a wavelength of 782 nm increases over the layer thickness of 100 nm from approx. 2.5 to approx. 3.1. Thus, within the at least one silicon layer (Si:H) deposited with the addition of hydrogen gas the refractive index n for light with a wavelength of 782 nm increases over the layer thickness of 100 nm by more than 20%, approx. by 24%.

An advantage of providing a refractive index gradient in a single silicon layer is that a single layer can function as an interference filter and therefore does not require any or requires a reduced deposition of multiple layers, compared to prior art coating with layers having a constant uniform refractive index.

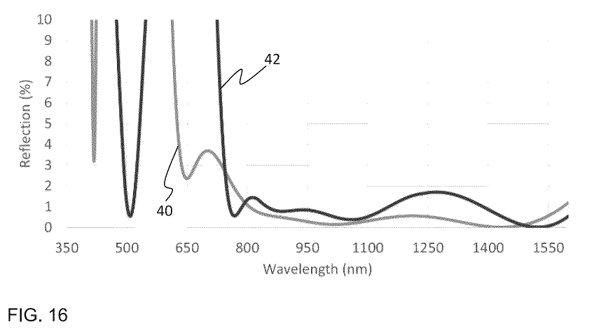

For applications of the invention as a coating on housing of LiDAR systems, a key property requirement is high transmission above 900 nm and minimal transmission in the UV-VIS range. FIGS. 16 to 18 show the optical behavior of two coatings with regard to these key property requirements, namely solid curves 40 indicate the optical behavior of a coating according to an embodiment provided according to the invention having a refractive index gradient, while dashed curves 42 indicate the optical behavior of a prior art coating.

FIG. 16 shows the reflection of two coatings which are optimized for low reflection in the NIR. The curves represent reflections of a coating comprising an alternating arrangement of five silicon (Si:H) layers with carbon content gradient and five silicon dioxide (SiO₂) layers indicated by solid curve 40 and of a prior art coating comprising an alternating arrangement of six silicon (Si:H) layers without gradient and six silicon dioxide (SiO₂) layers indicated by dashed curve 42. More precisely, FIG. 16 shows that the coating provided according to the invention comprising silicon (Si:H) layers with a carbon content gradient needs only a total number of ten layers in order to reach an average reflection of 0.37% in the range of 800-1600 nm. The prior art coating comprising silicon (Si:H) layers without a carbon content gradient needs a number of twelve layers in order to attain an average reflection of 0.84% in the 800-1600 nm range. Hence, the coating system having a carbon content gradient and thus a refractive index gradient requires less layers than a common prior art system for substantially the same performance.

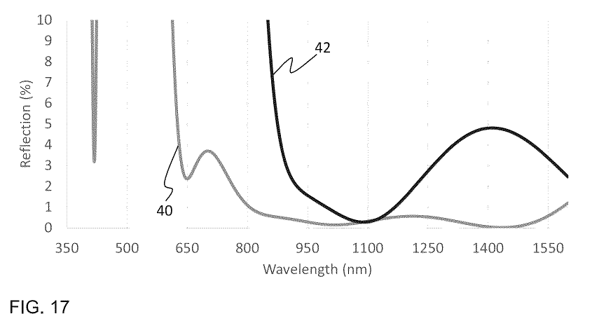

FIG. 17 shows the reflection of a coating according to an embodiment provided according to the invention (i.e. with gradient) and a prior art coating (i.e. without gradient) which have the same thickness of approx. 530 nm (360 nm Sio2+170 Si:H) and comprise the same number of layers, namely ten layers which each have the same thickness. Hence, in FIG. 17 solid curve 40 represents a coating with an alternating arrangement of five silicon (Si:H) layers with carbon content gradient and five silicon dioxide (SiO₂) layers, while dashed curve 42 represents a coating with an alternating arrangement of five silicon (Si:H) layers without carbon content gradient and five silicon dioxide (SiO₂) layers. As can be seen in FIG. 17, there is a significant difference in the optical behaviour between the two types of coatings when the same number of layers is used, with the same thickness for each layer. Compared to a coating provided according to the invention, the average reflection of the prior art coating having no gradient is increased by more than 6.7% for wavelengths between 380 nm and 800 nm. In order to obtain the desired optical absorption effect/filtering effect in the UV-VIS range, there is an optimal thickness. This can be achieved either through increasing the total coating or the number of the total layers needs to be increased.

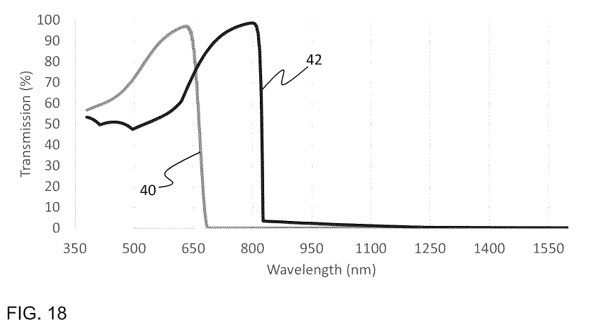

FIG. 18 shows the transmission of the coatings of FIG. 17. Hence, in FIG. 18 solid curve 40 represents a coating with an alternating arrangement of five silicon (Si:H) layers with carbon content gradient and five silicon dioxide (SiO₂) layers, while dashed curve 42 represents a coating with an alternating arrangement of five silicon (Si:H) layers without carbon content gradient and five silicon dioxide (SiO₂) layers. As can be seen in FIG. 18, there is a significant difference in the optical behaviour between the two types of coatings when the same number of layers is used, with the same thickness for each layer. Compared to a coating provided according to the invention, the average transmission of the prior art coating having no gradient is reduced by more than 20-25% for wavelengths between 380 nm and 800 nm. In order to obtain the desired optical absorption effect/filtering effect in the UV-VIS range, there is an optimal thickness. This can be achieved either through increasing the total coating or the number of the total layers needs to be increased.

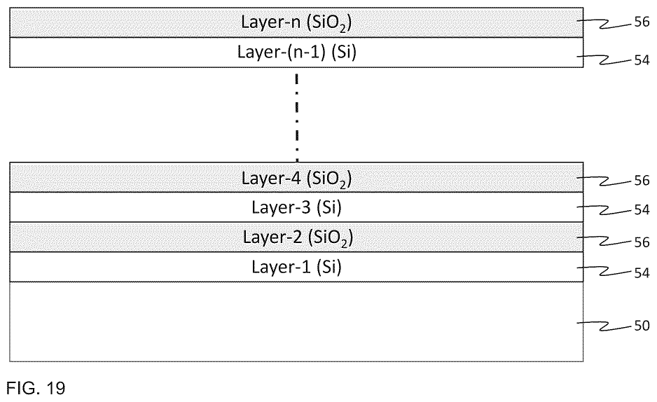

FIG. 19 shows a schematic view of a glass substrate 50 which is coated with a multilayer coating 52. The multilayer coating 52 comprises a plurality of alternating Si-layers 54 and SiO₂-layers 56. The Si-layers 54 are provided with a carbon content gradient of the above described type. Exemplarily, six layers, namely three Si-layers 54 and three SiO₂-layers are shown in FIG. 19. However, as indicated in FIG. 19 there may be a plurality of layers. The number of layers is not limited by the shown layer number.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### LIST OF REFERENCE SIGNS

9 representation of silicon layer with carbon content gradient
11 representation of silicon layer with carbon content gradient
13 representation of silicon layer with carbon content gradient
20 representation of external surface of the silicon layer with carbon content gradient (refractive index)
22 representation of external surface of the silicon layer with carbon content gradient (refractive index)
24 representation of substrate side surface of the silicon layer with carbon content gradient (refractive index)
26 representation of substrate side surface of the silicon layer with carbon content gradient (refractive index)
28 representation of external surface of the silicon layer with carbon content gradient (absorption coefficient)
30 representation of external surface of the silicon layer with carbon content gradient (absorption coefficient)
32 representation of substrate side surface of the silicon layer with carbon content gradient (absorption coefficient)
34 representation of substrate side surface of the silicon layer with carbon content gradient (absorption coefficient)
36 representation of a silicon layer deposited without the addition of hydrogen gas (refractive index)
38 representation of a silicon layer deposited with the addition of hydrogen gas (refractive index)
40 representation of optical behavior of a coating having a refractive index gradient
42 representation of optical behavior of a coating without refractive index gradient
GD layer or coating growth direction
50 glass substrate
52 multilayer coating
54 Si-layer
56 SiO₂-layer

What is claimed is:

1. A coating for a glass substrate, the coating being a multilayer coating comprising at least one silicon layer, the at least one silicon layer having a carbon content gradient over its layer thickness.

2. The coating of claim 1, wherein the at least one silicon layer comprises at least 95 atomic-% silicon.

3. The coating of claim 2, wherein the at least one silicon layer comprises at least 97 atomic-% silicon.

4. The coating of claim 1, wherein the at least one silicon layer comprises less than 5% carbon and/or hydrogen.

5. The coating of claim 4, wherein the at least one silicon layer comprises less than 3% carbon and/or hydrogen.

6. The coating of claim 1, wherein the at least one silicon layer comprises a thickness section of 50 nm over which the carbon content increases at least 0.1% viewed in a direction away from the glass substrate.

7. The coating of claim 6, wherein the carbon content increases at least 1% viewed in the direction away from the glass substrate.

8. The coating of claim 1, wherein, when measuring the carbon content by a Time-of-Flight Secondary Ion Mass Spectrometry (ToF-SIMS) analysis with Ga at 25 keV and normalizing the measurement results relative to 30Si-isotope, for a ratio R between a carbon content C₀ at a sputter time T₀ and a carbon content C₁ at a sputter time T₁ the following condition applies:
$$R = \frac{{C}_{0} ( {T}_{0} )}{{C}_{1} ( {T}_{1} )} = \frac{{C}_{0} ( {T}_{0} )}{{C}_{1} ( {T}_{0} + 3500 [ s ] )} \geq 1.2 .$$

9. The coating of claim 8, wherein R≥1.4.

10. The coating of claim 1, wherein the multilayer coating comprises a plurality of silicon layers and further comprises at least one silicon dioxide layer.

11. The coating of claim 1, wherein the at least one silicon layer is a hydrogenated silicon layer.

12. The coating of claim 1, wherein at least one of the following is satisfied:
the coating has an average transmission for light with wavelengths between 400 nm and 700 nm of less than 10%; or
the coating has an average transmission for light with wavelengths between 780 nm and 3 μm of at least 90%.

13. The coating of claim 1, wherein at least one of the following is satisfied:
the at least one silicon layer has a hydrogen content gradient over its layer thickness; or
the at least one silicon layer has a fluorine content gradient over its layer thickness.

14. A glass substrate, comprising:
at least one surface portion; and
a coating provided on the at least one surface portion, the coating being a multilayer coating comprising at least one silicon layer, the at least one silicon layer having a carbon content gradient over its layer thickness.

15. The glass substrate of claim 14, wherein the at least one surface portion has a curved shape.

16. The glass substrate of claim 14, wherein the glass substrate comprises silicate glass, borosilicate glass, or aluminosilicate glass.

17. A method for producing a coating on a substrate, the method comprising:
providing the substrate in a vacuum chamber; and
depositing at least one layer to the substrate by a chemical vapor deposition method, wherein the at least one layer is a silicon layer having a carbon content gradient over its layer thickness.

18. The method of claim 17, wherein the chemical vapor deposition method is a plasma impulse chemical vapor deposition method,

19. The method of claim 17, wherein silane gas is used as reacting gas for depositing the at least one silicon layer.

20. The method of claim 17, wherein the at least one silicon layer is hydrogenated during depositing by supplying hydrogen gas into the vacuum chamber.
